(19) United States
(12) Patent Application Publication
(10) Pub. No.: US 2026/0307134 A1
(43) Pub. Date: Oct. 8, 2026

(54) Manufacturing pre-form blanks via laminated object manufacturing

(71) Applicant: Alloy Enterprises Inc., Burlington, MA (US)

(72) Inventors: Sean Geier, Cambridge, MA (US); Paul Titchener, Somerville, MA (US); Wyatt Andree, Revere, MA (US); Kevin Simon, Cambridge, MA (US); Nicholas Mykulowycz, Boxford, MA (US)

(21) Appl. No.: 19/484,867

(22) PCT Filed: May 30, 2024
(86) PCT No.: PCT/US2024/031709

§ 371 Date: Nov. 16, 2025

Related U.S. Application Data
(60) Provisional application No. 63/505,040, filed on May 30, 2023.

(51) Int. Cl. B21D 35/00; B33Y 30/00

(52) U.S. Cl. CPC B21D 35/007; B33Y 30/00

(57) ABSTRACT

Methods and systems for the laminated object manufacturing of metal parts. Some embodiments include a method that includes bonding a plurality of metal sheets to form a workpiece comprising at least one pre-form blank having a variable thickness and at least one support region; and subjecting the workpiece to a mechanical forming process to form the part from the at least one pre-form blank.

### CROSS-REFERENCE TO RELATED APPLICATIONS

The present application claims the benefit of and priority to U.S. Provisional Application No. 63/505,040, filed on May 30, 2023, the entire disclosure of which is hereby incorporated by reference as if set forth in its entirety herein.

### TECHNICAL FIELD

Embodiments described herein generally relate to methods and apparatus for fabricating metal laminated object parts, and more specifically to the manufacture of pre-form blanks via laminated object manufacturing.

### BACKGROUND

In traditional additive manufacturing methods such as laminated object manufacturing (LOM), assembling complex 3D structures involves sequentially adding layers of material to a structure. Each successive layer is bonded to and/or deposited on the previous layer to gradually assemble the 3D structure. Often these layers are cut or shaped prior to being incorporated into the part. The layers may include a wide variety of materials, including various metals.

In many scenarios, metal parts assembled from additive layers may need to undergo further processing to form a final workpiece. However, such processing may introduce various manufacturing challenges. For example, metal parts may have additional volumes cut out of constituent metal layers corresponding to void spaces that support additional processing such as isostatic pressing. However, metal parts with large void spaces or curvature may result in low packing density and large supporting structures for deposition, which may greatly increase processing time and cost. Other parts with complicated 3D geometries may have sections comprised of several segmented layers bonded together. Parts assembled in this fashion may be weaker than a part where a single layer conforms to the contour of the part. Additionally, enclosure parts for applications such as electronics and automotive frames may require multiple mounting points on a contour, which may be costly to manufacture.

Accordingly, a need exists for improved methods and systems of additive manufacturing of metal parts.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method for producing a part via laminated object manufacturing. The method includes bonding a plurality of metal sheets to form a workpiece comprising at least one pre-form blank and at least one support region; and subjecting the workpiece to a mechanical forming process to form the part from the at least one pre-form blank.

In some embodiments, the pre-form blank has a varying thickness across a plane of the workpiece.

In some embodiments, the varying thickness facilitates the mechanical forming process.

In some embodiments, the mechanical forming process causes the varying thickness of the at least one pre-form blank to change continuously.

In some embodiments, the method further includes the removal of the at least one support region prior to the mechanical forming process.

In some embodiments, the mechanical forming process includes one or more of folding, pressing, stamping, bending, punching, coining, drawing, or hydroforming.

In some embodiments, the at least one pre-form blank includes at least one indent.

In some embodiments, the at least one indent promotes bending at a region of the at least one pre-form blank during the mechanical forming process.

In some embodiments, the formed workpiece includes at least one alignment feature that facilitates the mechanical forming process.

In some embodiments, the at least one alignment feature includes one or more of holes, slots, rivets, or brackets.

In some embodiments, the at least one alignment feature includes at least one rivet, and wherein the mechanical forming process causes the at least one rivet to contact a surface of the part for subsequent riveting.

In some embodiments, the mechanical forming process changes the volume of at least part of the workpiece.

In some embodiments, each of the plurality of metal sheets includes an individual pattern for forming different features of the part.

In some embodiments, the individual patterns of the plurality of metal sheets includes a pattern of channels suitable for carrying a fluid.

In another aspect, embodiments relate to a system for producing a part via laminated object manufacturing. The system includes an additive manufacturing device configured to bond a plurality of metal sheets to form a workpiece comprising at least one pre-form blank and at least one support region; and a forming machine configured to subject the workpiece to a mechanical forming process to form the part from the at least one pre-form blank.

In some embodiments, the pre-form blank has a varying thickness across a plane of the workpiece.

In some embodiments, the varying thickness facilitates the mechanical forming process.

In some embodiments, the mechanical forming process comprises one or more of folding, pressing, stamping, bending, punching, coining, drawing, or hydroforming.

In some embodiments, the at least one pre-form blank comprises at least one indent configured to promote bending at a region of the at least one pre-form blank during the mechanical forming process.

In some embodiments, the mechanical forming process changes the volume of at least part of the workpiece.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified:

FIG. 1 depicts a part that has been formed from a pre-form blank that is depicted in phantom below the pre-form blank;

FIG. 2 depicts an edge-on view of the pre-form blank and the formed part of FIG. 1;

FIG. 3 depicts a pre-form blank comprising three metal sheets;

FIG. 4 depicts the blank in FIG. 3 after forming;

FIG. 5 depicts the cross-section of a pre-form blank that includes three metal sheets to be bent into a part;

FIG. 6 depicts the pre-form blank of FIG. 5 bent into its final shape;

FIG. 7 depicts a pre-form blank comprising a part region, facial support structures, and side support structures;

FIG. 8 depicts the pre-form blank of FIG. 7 after the pre-form blank has undergone the forming process;

FIG. 9 depicts the formed blank of FIG. 8 with the support structures removed;

FIG. 10 depicts a pre-form blank consisting of a part region;

FIG. 11 depicts the blank of FIG. 10 after an initial forming step;

FIG. 12 depicts the partially formed part of FIG. 11 after a subsequent forming step;

FIG. 13 depicts a blank to be formed into a part during a forming process;

FIG. 14 depicts the blank of FIG. 13 formed to its final part geometry;

FIG. 15 depicts the initial configuration of a light-weighted blank;

FIG. 16 depicts the light-weighted blank from FIG. 15 with a region bent into contact with the surface of a void space;

FIG. 17 depicts the light-weighted blank from FIG. 16 subsequently formed into a part;

FIG. 18 depicts a cross-section of a pre-form blank comprised of four metal sheets prior to being formed; and

FIG. 19 depicts the blank of FIG. 18 after forming.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

### Definitions

Unless otherwise specified, the following terms as used herein shall have the meanings as provided below:

The term “workpiece” refers to a stack of metal sheets to be bonded into at least one part and at least one corresponding support structure.

The term “metal sheet” refers to a metal sheet or foil that is stacked in the workpiece. Each metal sheet may be patterned to contain part regions and support structure regions. In some embodiments, the metal sheet may comprise at least one of aluminum, copper, magnesium, titanium, aluminum alloy, magnesium alloy, and/or titanium alloy.

The term “sheet” refers generally to a metallic layer between 25 μm to 10 cm in thickness.

The term “blank” refers to an intermediate product after the bonding process is completed, but prior to being formed into the final part geometry.

The term “forming” refers to a post-bonding process step where the part is bent, coined, notched, pressed, punched, stamped, or otherwise shaped from its initial geometry to its final geometry.

The term “part” refers to the final product of the process, which is a blank that has been formed into its final geometry.

The term “void” refers to a volume cut out of a metal sheet in the support or part region which is fully enclosed and not fluidically connected to any other internal channel or port within the workpiece.

The term “void space” refers to a pattern of voids intentionally cut in a given volume or region that are later affected by the isostatic pressing process.

### Embodiments

Embodiments of this invention include methods and systems to manufacture thin, variable thickness metal blanks via laminated object manufacturing for the purpose of forming into a part with a different 3D geometry. These methods and systems may include design rules for the placement and patterning of metal sheets in a fashion that minimizes the number of sheets required to form the blank and account for deformation in the part forming process. Some embodiments may include specific alignment features that allow the at least one pre-form blank to be easily aligned and formed into the final geometry. Some embodiments may include specific reinforcement features that mechanically support the geometry of the final part, and features that allow the part to be more easily mounted or integrated into an assembly. Combinations of these embodiments may enable the production of complex parts such as vehicle frames and electronics enclosures. Examples on how these methods and systems may be implemented are discussed in further detail below.

### Workpieces

In embodiments of this invention, a workpiece consisting of a plurality of metal sheets may be assembled and bonded. The workpiece may be assembled in a laminated fashion with the metal sheets. In this manner, the workpiece may be a layered workpiece assembled by depositing the metal sheets. The metal sheets may be patterned such that the pattern of the metal sheets partitions the workpiece into at least one pre-form blank and at least one support structure. The workpiece may be bonded in a heated press, a more complicated bonding machine comprising a heated press and a vacuum chamber, and/or a bonding machine of any configuration appropriate for laminated object manufacturing of metal parts.

In some embodiments, after bonding, the pre-form blank may be subsequently separated from at least a portion of the support structure, and then formed into a part. The pre-form blank may be fully extracted from the support structure prior to being formed into a part. The forming process may consist of mechanical translations such as pressing, stamping, bending, hydroforming, and/or other processes that alter the geometry of the pre-form blank. The forming process may create at least one enclosure within the part and have a greater enclosed volume than the pre-form blank. The part may then be finished with various post-forming processes. Additional alignment and reinforcement features on the pre-form blank may be engaged during the forming process to further shape the part, which are further described below.

In some embodiments, the forming process may transform the geometries of the component metal sheets. In some embodiments, the metal sheets may be patterned and configured such that when formed into the final part geometry, the surface of one metal sheet may be traced through a portion (e.g., a majority portion) of the part.

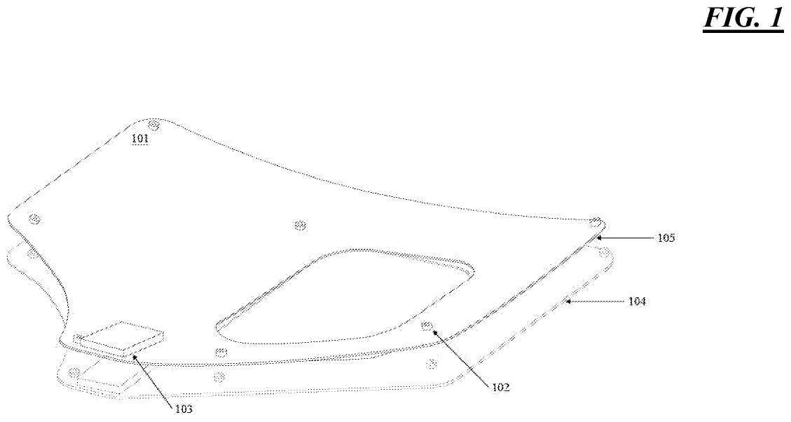

FIG. 1 depicts a part 101 that has been formed from a pre-form blank 104 depicted in phantom beneath the part 101. The part 101 may have a curved geometry after the forming process. As shown, the part 101 may include surface features such as screw bosses 102 and an indented panel 103. The blank 104 may be flat and comprised of any number of metal sheets. The total thickness of the metal sheets may less than and/or equivalent to the total height of a final part 105. The final part 105 may be formed from the part 101 after various post-forming processes.

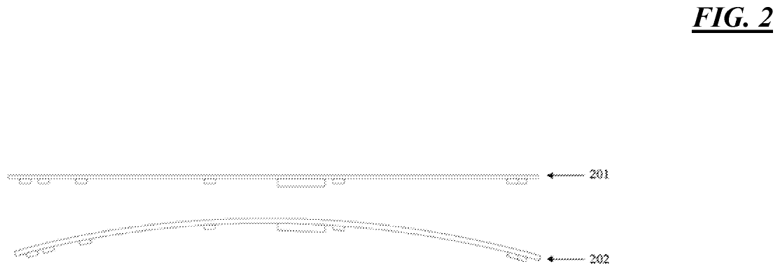

FIG. 2 depicts an edge-on view of the pre-form blank and the formed part of FIG. 1. The pre-form blank 201 may have a total thickness less than the corresponding formed part 202. A single metal sheet may be tracked through the length of the pre-form blank 201 and the formed part 202.

### Design Rules

In some embodiments, the metal sheets comprising the workpiece may be patterned in a way that supports and/or facilitates the bonding and forming processes. The metal sheets may be patterned prior to being stacked into a workpiece according to a model that takes into account thermal and mechanical deformations that occur during bonding and forming.

In some embodiments, each metal sheet may be individually patterned for forming different features of the part. The metal sheets may have different dimensions along a specified plane, such as a plane orthogonal and/or parallel to the axis of force applied to the metal sheets. This may result in the workpiece having a varying thickness across the plane. The varying thickness may support and/or facilitate the bonding and forming processes.

In some embodiments, the metal sheets may be patterned so that the workpiece contains a series of indentations in the blank region where the forming is to take place. The series of indentations may be in one or more rows.

In some embodiments, the metal sheets may be patterned so that the workpiece contains a perforation line in the blank region where forming is to take place.

In some embodiments, the metal sheets may be patterned so that the workpiece contains a pattern of void spaces. The void spaces may be formed from regular, geometric patterns and/or random distributions within the workpiece. In some embodiments, the void space may consist of a distribution of microscopic voids. The metal sheets may comprise roughened, textured, and/or patterned surfaces to form the microscopic voids. The void spaces may facilitate the removal of support structures or parts from the workpiece (e.g., before or during the forming process) by aiding in imploding or fracturing the support structure or parts. The void spaces may direct force during the forming process to produce the desired part geometry. The void spaces may also deform in a fashion that produces the desired part geometry.

In some embodiments, the metal sheets may be patterned so that the workpiece contains a pattern of channels suitable for carrying a gas or fluid. The pattern of channels may be formed from a pattern of void spaces in the metal sheets. When layers of metal sheets with these void spaces are stacked together, the void spaces across the layers may form channels that allow a gas or fluid to flow therein.

In some embodiments, the support structure may be portioned. The part may be formed within that portioned support structure. In other embodiments, at least one portion of the support structure may be removed between the bonding and forming steps, and at least one portion may remain attached to the workpiece between the bonding and forming steps. This additional portion of the support structure may be removed after any forming step, such as during various post-forming processes.

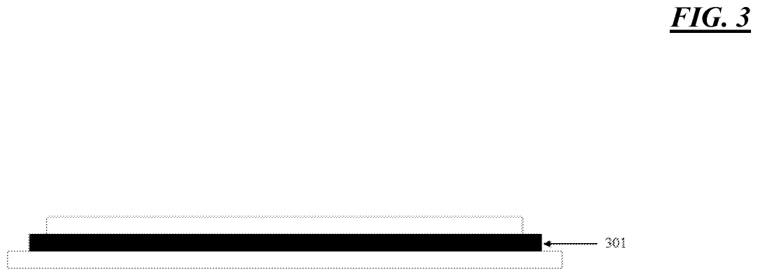

FIG. 3 depicts a pre-form blank comprising three metal sheets. A middle sheet 301 in the pre-form blank is highlighted but may otherwise be materially similar to the other metal sheets. As shown, the three metal sheets may differ in dimension along a plane orthogonal to the axis of force applied to the pre-form blank. The different dimensions of the three metal sheets may result in a varying thickness of the pre-form blank along the plane (and/or any other suitable plane).

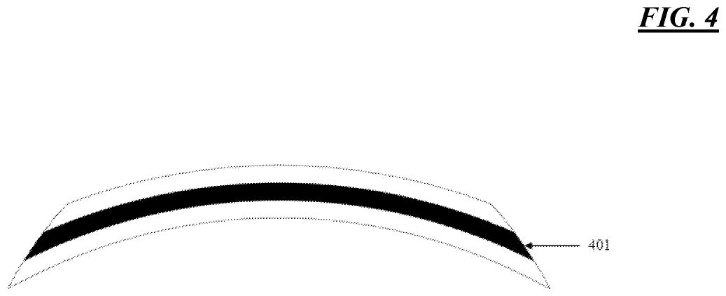

FIG. 4 depicts the blank in FIG. 3 after forming. The overall cross-sectional area of the part after forming is the same as the cross-sectional area of the blank prior to forming. The forming process may deform the constituent metal sheets, including the traced metal sheet 401. The rectilinear edges on the blank may be smoothed by the forming process, obscuring the boundary between adjacent layers. This may result in the varying thickness of the part to change continuously. The post-formed traced metal sheet may occupy a volume that has a greater height than the height of the pre-formed traced metal sheet (e.g., as a result of bending and/or curving after forming).

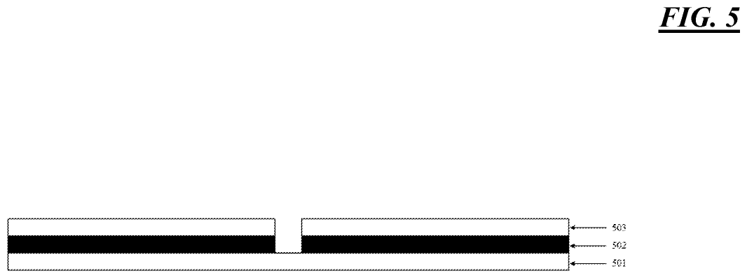

FIG. 5 depicts the cross-section of a pre-form blank that includes three metal sheets to be bent into a part. A base metal sheet 501 is the first layer of the pre-form blank. The next two layers of the pre-form blank may include additional metal sheets 502 and 503 with an indent cut into the metal sheets. The indent may result from the three metal sheets differing in dimensions. The second metal sheet 502 is traced but is otherwise materially similar to the first and third metal sheets.

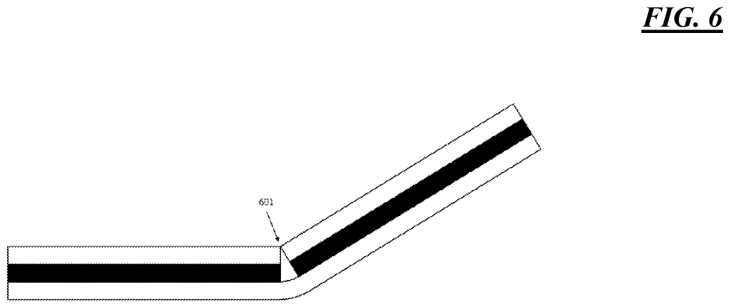

FIG. 6 depicts the pre-form blank of FIG. 5 bent into its final shape. The indent 601 may be collapsed, allowing the part to occupy a different geometry than the pre-form blank by bending along an axis of the indent.

### Alignment Features

In some embodiments, specific alignment features may be included on the part that allow it to be aligned in a second machine for forming. Examples of these alignment features may include holes or slots for registration pins, slots or keys for positional and angular alignment, indents, and/or alignment marks or indicators. Examples of these alignment features also may include brackets and/or other raised features (e.g., protrusions) that can be aligned with a jig or support structure on the machine. Alignment features may be incorporated into at least one of the preform blank and a portion of the support structure.

In some embodiments, features that guide the forming process may be incorporated into the workpiece prior to bonding. These features may include perforations, indentations, and/or raised surface features that serve to direct the force applied by the forming process.

In some embodiments, alignment features on the support structure may be inhibited from bonding or otherwise weakly bonded so the features may readily break away from the part after the forming process is complete.

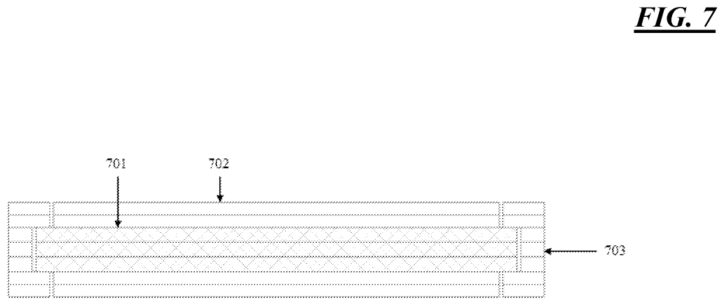

FIG. 7 depicts a pre-form blank comprising a part region 701, facial support structures 702, and side support structures 703. The facial support structures may prevent damage to the part region during the forming process. At least one of the facial support structures 702 and side support structures 703 may have aligning features that enable the pre-form blank to be loaded into the forming machine.

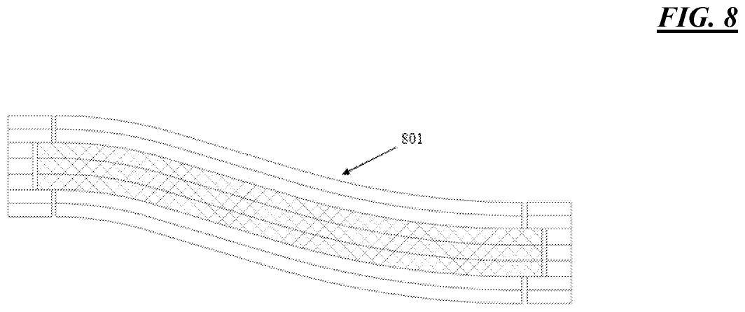

FIG. 8 depicts the pre-form blank of FIG. 7 after the pre-form blank has undergone the forming process. The support structure and part regions may be pressed into a new shape 801. As shown, the support structure and part region may be pressed to form a curve.

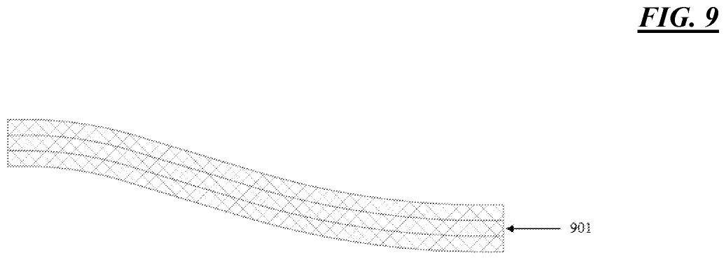

FIG. 9 depicts the formed blank of FIG. 8 with the support structures removed, leaving a finished part 901.

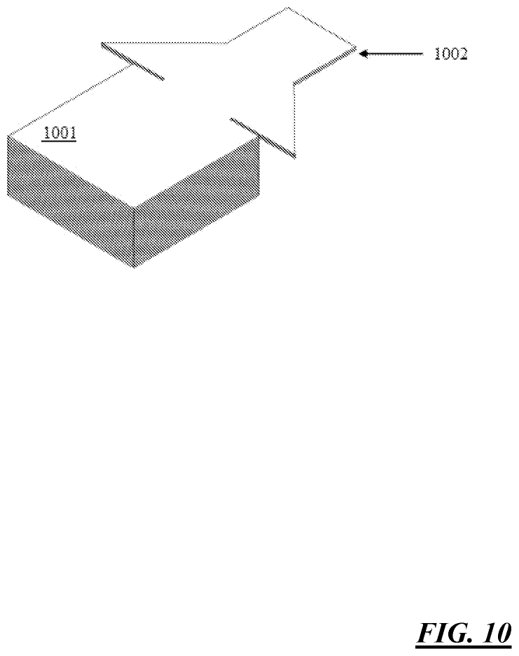

FIG. 10 depicts a pre-form blank consisting of a part region 1001. A blank region 1002 may be comprised of a smaller number of metal sheets that will be formed into a gusseted bracket during subsequent forming steps. As shown, the blank region 1002 may result from a number of metal sheets having a larger dimension along a plane parallel to the axis of force applied to the pre-form blank.

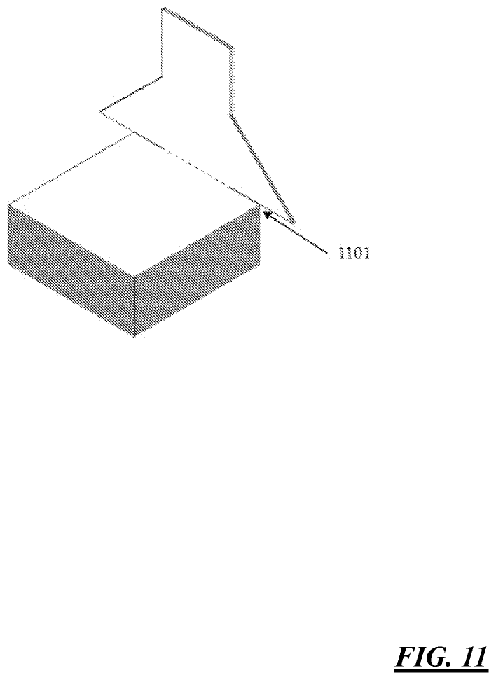

FIG. 11 depicts the blank of FIG. 10 after an initial forming step to form a partially formed part. The blank region may be bent into a position 1101 to form an angled bracket.

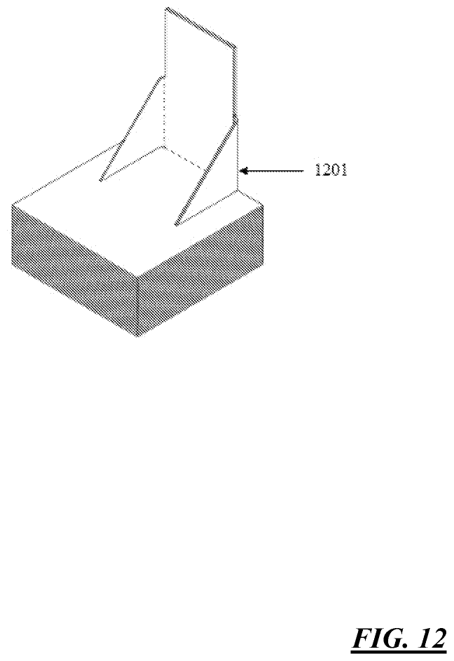

FIG. 12 depicts the partially formed part of FIG. 11 after a subsequent forming step. Gussets 1201 may be bent into place above a part region to form a gusseted bracket. The gusset-part interface may be subsequently welded or otherwise fastened to the part to increase reinforcement.

### Reinforcement Features

In some embodiments, reinforcement features may be added to the blank that will increase the strength of the formed part. These may include thicker regions of the part for providing added stiffness or durability, such as trusses (e.g., for roof or bridge assemblies), gussets, embedded fibers, ribs, fillets, and/or fillet welds. Additionally and/or alternatively, these features may include penetrations (e.g., holes, cutouts, threads, passages, ports, notches, channels, etc.) for mounting brackets, holes for bolts, rivets, or other fasteners, and/or screw bosses that receive bolts or other fasteners.

In some embodiments, at least one surface feature may come into contact with another surface of the part after forming. This surface feature may be subsequently welded, fastened, and/or otherwise secured to reinforce the finished part. The surface feature may include features capable of riveting or fastening to another surface of the part upon contact with the surface, such as self-piercing rivets, snap-fit connectors, and/or interlocking joints.

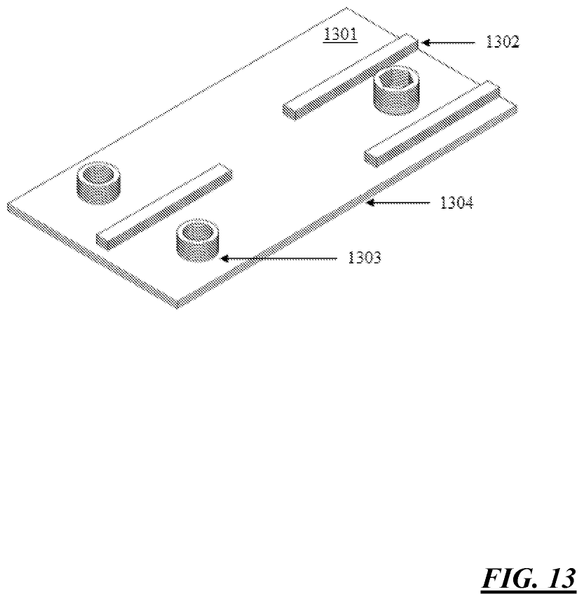

FIG. 13 depicts a blank 1301 to be formed into a part during a forming process. The blank 1301 may be formed of at least one metal sheet. Surface features such as reinforcing ribs 1302 and screw bosses 1303 may be assembled on the blank. An indentation line 1304 may be cut on at least one of the foil sheets in the blank to serve as a guide for the forming process.

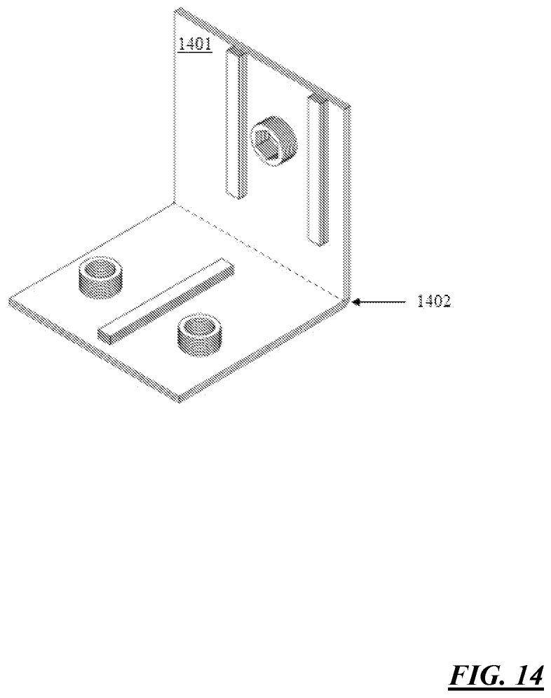

FIG. 14 depicts the blank of FIG. 13 formed to its final part geometry. The part 1401 may be comprised of the blank of FIG. 13 folded along an indentation line 1402.

### Internal Features

In some embodiments, metal sheets may be patterned in the workpiece such that penetrations are formed in the part, which may later be filled with an insert. These inserts may include threaded inserts or bushings for receiving screws. These inserts may include anchors or insert nuts. These inserts may include press-fit or potted inserts, which may be secured with adhesives such as epoxy resins, vinyl ester resins, polyester resins, cyanoacrylate, silicone adhesives, acrylic adhesives, and/or polyurethane adhesives.

In some embodiments, the metal sheets may be patterned in the workpiece such that an internal void geometry may be enclosed within the part. This may reduce the weight of the part to form a light-weighted part by removing excess mass while retaining strength in at least one dimension, such as a dimension parallel and/or orthogonal to the axis of force applied to the workpiece. The process may consist of bonding a blank that has a void-containing geometry in one blank subregion and at least a second blank subregion. The forming process may subsequently bend the second blank region in contact with the first blank region, enclosing the void-containing geometry. This void-containing geometry may include a pattern of channels, a pattern of metal walls and void space creating a honeycomb-like structure, a pattern of closed cell voids, a pattern of microscopic voids, and/or another surface texture. The void-containing geometry may have any type of geometry within a top-down and/or side-view cross section, such as rectilinear, circular, cylindrical, ellipsoid, triangular, polygonal, and/or elongated. The volume of the void-containing geometry measured against the total geometric volume of the part may be termed “percent void space.” In some embodiments, the percent void space may comprise a minority of the geometric volume of the part. In some embodiments, the percent void space may comprise the majority of the geometric volume of the part.

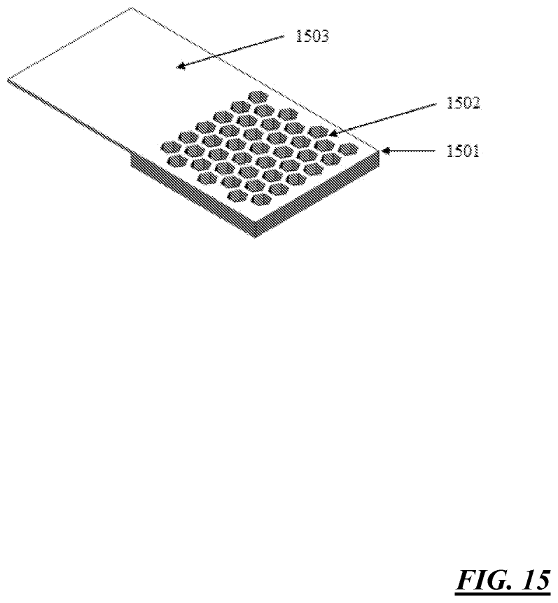

FIG. 15 depicts the initial configuration of a light-weighted blank 1501. At least one portion of the blank may comprise a structure containing a void space 1502, and at least one portion 1503 of the blank may be configured to cover the void space 1502. As shown, the void space 1502 may include a honeycomb-like structure.

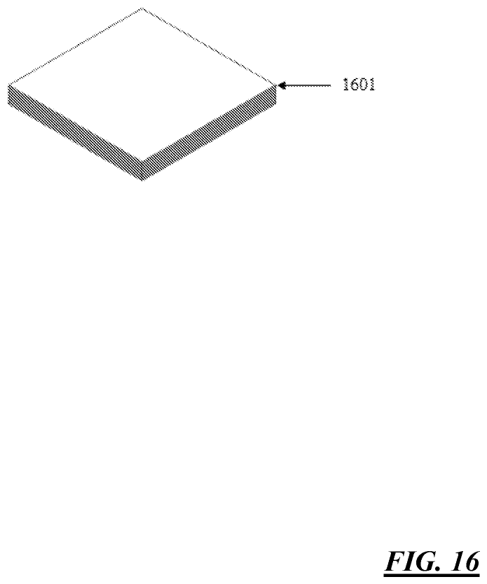

FIG. 16 depicts the light-weighted blank from FIG. 15 with the region 1503 bent into contact with the surface of the void space 1502. A cover region 1601 of the blank may be adjacent to the light-weighted honeycomb region. Alternately, the light-weighted blank in FIG. 16 may be constructed directly with a light-weighted interior enclosed within the part, bypassing the first forming step to produce a blank in this configuration from FIG. 15.

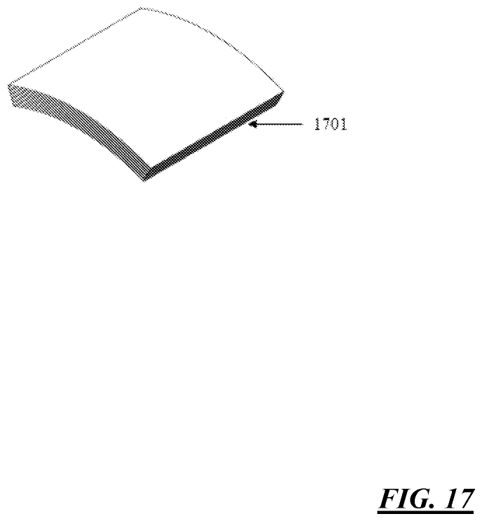

FIG. 17 depicts the light-weighted blank from FIG. 16 subsequently formed into a part. The blank may be bent along at least one curve 1701 to form a light-weighted, curved part.

### Forming Process

In some embodiments, a blank may be removed from at least a portion of its support structure and formed into a part. The forming process may consist of one or more process steps. These forming process steps may include at least one bending, rolling, stretching, folding, stamping, metal spinning, pressing, punching, coining, and/or drawing step. The forming machine for performing the forming process steps may comprise at least one of a single die tool, a multi-die tool, a progressive die tool, a press brake, a rolling machine, a punch, a stamping press, a hydraulic press, a forging press, and/or an extrusion machine. The forming process may consist of at least one hydroforming step, such as for forming ductile metal sheets. The hydraulic fluid for the hydroforming step may be mineral oil-based or water-based. After the forming process, any remaining portions of the support structure may optionally be removed.

In some embodiments, the forming process may occur before or after the part is optionally homogenized. The forming process may occur before or after the part undergoes solutionization and quenching. In some embodiments, the solutionization and/or quenching may occur in the same processing unit used for homogenizing the part. The forming process may also occur before or after the part is optionally subjected to isostatic pressing (e.g., via fracturing and/or imploding of void spaces).

In some embodiments, the forming process may result in thermal and mechanical deformations that affect the surface topology of the part. The forming process may plastically deform the surface of the part, smoothing angular surface features so that the thickness of the part changes continuously. Embodiments may result in the smoothing of the visible edges of discretized layers.

In some embodiments, the bonded pre-form blank may be formable or bendable by hand.

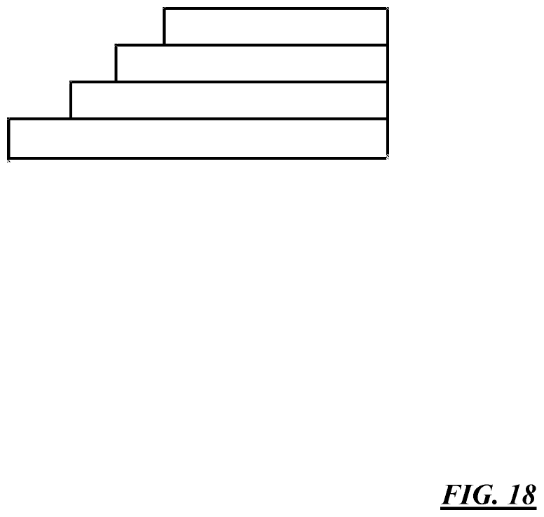

FIG. 18 depicts a cross-section of a pre-form blank comprised of four metal sheets prior to being formed. The pre-form blank may have a varying thickness along a plane of the pre-form blank, resulting in at least one discrete edge of the pre-form blank.

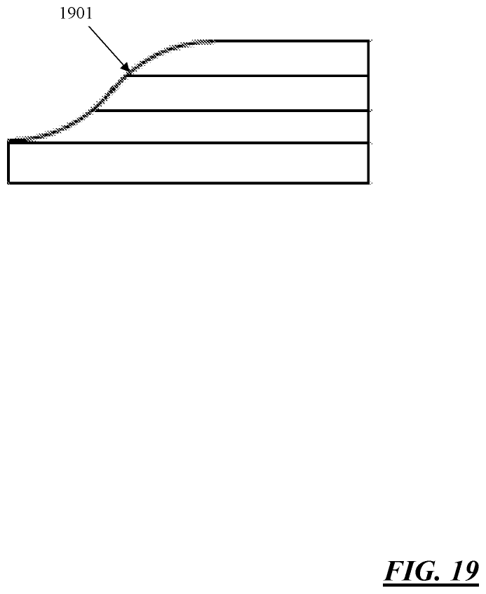

FIG. 19 depicts the blank of FIG. 18 after forming. Thermal and mechanical deformations may occur during the forming process that smooths the edges of the four constituent metal sheets 1901. This may result in the thickness of the pre-form blank to change continuously after the forming process.

### Post-Processing

In some embodiments, the formed part may be subsequently machined to finish the surface features of the formed part. Post-forming processes may include at least one tapping, polishing, and/or welding step. After the post-processing, any remaining portions of the support structure may optionally be removed. Post-forming process steps may occur before or after the part is optionally homogenized. Post-forming process steps may occur before or after the part undergoes solutionization and quenching. Post-forming process steps may occur before or after the part is optionally subjected to isostatic pressing. The part may be optionally precipitation-hardened after forming.

In some embodiments, a part may be faced to remove curvatures and/or imperfections on the surface that interfaces with a second part.

In some embodiments, subsequent machining may involve tap and die tooling to thread for fasteners. The threading may be external or internal to the part. For example, this subsequent machining may involve threading standing posts externally. The subsequent machining may include drilling and threading standing posts internally to receive screws and/or other fasteners. The subsequent machining may include tap and die to thread holes in the part for receiving screws and/or other fasteners.

In some embodiments, at least one surface portion on the part may be welded to another surface portion of the part. For example, a rib may be completed by welding two distinct regions together to reinforce and stiffen the part. Alternatively, at least two surfaces may be bent into contact along an edge and welded to form a 3D structure.

In some embodiments, facing, polishing, sanding, grinding, chemical treatments (e.g., anodizing, electroplating, etc.), and/or other forms of surface finishing may be used to smooth the surface and obscure features such as discontinuities and/or burrs between the bonded and formed metal sheets. In some embodiments, the part may be coated and/or plated.

In some embodiments, heat treatments may be used to alter at least one mechanical property of the formed part, such as annealing, quenching, tempering, and/or case hardening.

### Equivalents

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

What is claimed is:

1. A method to produce a part via laminated object manufacturing, the method comprising:
bonding a plurality of metal sheets to form a workpiece comprising at least one pre-form blank and at least one support region; and
subjecting the workpiece to a mechanical forming process to form the part from the at least one pre-form blank.

2. The method of claim 1 wherein the pre-form blank has a varying thickness across a plane of the workpiece.

3. The method of claim 2 wherein the varying thickness facilitates the mechanical forming process.

4. The method of claim 2 wherein the mechanical forming process causes the varying thickness of the at least one pre-form blank to change continuously.

5. The method of claim 1 wherein the method further comprises the removal of the at least one support region prior to the mechanical forming process.

6. The method of claim 1 wherein the mechanical forming process comprises one or more of folding, pressing, stamping, bending, punching, coining, drawing, or hydroforming.

7. The method of claim 1 wherein the at least one pre-form blank comprises at least one indent.

8. The method of claim 7 wherein the at least one indent promotes bending at a region of the at least one pre-form blank during the mechanical forming process.

9. The method of claim 1 wherein the formed workpiece comprises at least one alignment feature that facilitates the mechanical forming process.

10. The method of claim 9 wherein the at least one alignment feature comprises one or more of holes, slots, rivets, or brackets.

11. The method of claim 9 wherein the at least one alignment feature comprises at least one rivet, and wherein the mechanical forming process causes the at least one rivet to pass through holes in two different surfaces of the part.

12. The method of claim 1 wherein the mechanical forming process changes the enclosed volume of at least part of the workpiece.

13. The method of claim 1 wherein each of the plurality of metal sheets comprises an individual pattern for forming different features of the part.

14. The method of claim 1 wherein the individual patterns of the plurality of metal sheets comprises a pattern of channels suitable for carrying a fluid.

15. A system for additive manufacturing of a part via laminated object manufacturing, the system comprising:
an additive manufacturing device configured to bond a plurality of metal sheets to form a workpiece comprising at least one pre-form blank and at least one support region; and
a forming machine configured to subject the workpiece to a mechanical forming process to form the part from the at least one pre-form blank.

16. The system of claim 15 wherein the pre-form blank has a varying thickness across a plane of the workpiece.

17. The system of claim 16 wherein the varying thickness facilitates the mechanical forming process.

18. The system of claim 15 wherein the mechanical forming process comprises one or more of folding, pressing, stamping, bending, punching, coining, drawing, or hydroforming.

19. The system of claim 15 wherein the at least one pre-form blank comprises at least one indent configured to promote bending at a region of the at least one pre-form blank during the mechanical forming process.

20. The system of claim 15 wherein the mechanical forming process changes the volume of at least part of the workpiece.
